(19) United States
(12) Patent Application Publication
(10) Pub. No.: US 2002/0062339 A1
(43) Pub. Date: May 23, 2002

(54) Remote computer aided design system and method

(76) Inventors: Mason N. Carter, Bedminster, NJ (US); James J. Logothetis, East Stroudsburg, PA (US); Jayson E. Hahn, Secaucus, NJ (US)

Correspondence Address: DREW M. WINTRINGHAM, ESQ., CLIFFORD CHANCE ROGERS & WELLS LLP, 200 PARK AVENUE, NEW YORK, NY, 10166-0153, US

(21) Appl. No.: 09/510,468

(22) Filed: Feb. 22, 2000

(51) Int. Cl. G06G 7/62

(52) U.S. Cl. 709/203; 703/13

(57) ABSTRACT

A system and method is provided to allow designers to access a design system remotely. The design system allows a user to remotely utilize one or more engines to which access is provided by the remote design system provider. The engines, which offer a user an engine workspace where models may be built, synthesized, analyzed, and optimized, may physically reside on different servers. An optional feature is to provide access to a consultant for users requesting assistance during sessions.

### FIELD OF THE INVENTION

This invention relates to a system and method for remote computer aided design. More particularly, the remote computer aided design system and method of this invention allows a user to remotely utilize one or more engines to which access is provided by the remote design system provider.

### BACKGROUND OF THE INVENTION

As the complexity of electronic circuit design has increased over the last few decades, computer aided design (CAD) systems have become indispensable to designers. CAD systems, initially focusing on simply providing tools to draw schematic diagrams of circuits, mechanical structures, or other physical systems, have evolved to the point where users can design systems, compile components of the system representing theoretical or physical structures, and have an engine create simulations of the system functioning over time and in response to various stimuli. An example of a computer aided design system with some of these features is disclosed in U.S. Pat. No. 5,526,517 to Edwin et al.

Many designers today work on the modular level—the components utilized in the designing process are like “black boxes”, and the designer may not be aware of the details of how a component is built or what sub-components are used, as long as the properties of the component itself are known.

As design projects became more complex and companies started pulling teams of designers together, new challenges emerged in the designing process. One challenge is to provide a CAD system that allows the co-design of models, an example of which is a design process wherein a designer and a third party design together online, either interactively or separately. Another challenge is to provide a CAD system that allows models to be built using different types of pre-existing modules. Yet another challenge is to allow designers to have remote access, and, in particular remote access to several engines. The demands of modern CAD requirements are driving the need for improvements in technology and connectivity. Although advances in CAD systems, such as those outlined above, have helped improve productivity and reduce product cycles, it would be advantageous to provide more options and improve productivity even further. In sum, present technologies have limitations that the present invention, which provides a remote access computer aided co-design system, seeks to overcome.

### SUMMARY OF THE INVENTION

The present invention relates to a remote computer aided design system that allows users to remotely utilize engines whose access is provided by a remote design system provider. In one preferred embodiment, the user may choose the engine or engines used, providing an opportunity to use the most suitable engine or engines for a given set of data. In an alternative preferred embodiment, the choice is made by the provider, a computer, or a third party.

It is an object of this invention to provide a remote design system which offers a user an engine workspace where models may be built, synthesized, analyzed, and optimized.

It is another object of this invention to provide a remote design system that has the feature of providing access to a consultant for users requesting assistance during sessions.

It is another object of this invention to provide a remote design system which offers a plurality of engines from which a user may choose one or more engines.

It is another object of this invention to provide a remote design system that has access to engines that physically reside on different servers.

It is another object of this invention to provide engines that are available on a pay-per-use basis for remote design system session.

### BRIEF DESCRIPTION OF THE DRAWINGS

FIG. 1 is a flowchart of a preferred embodiment of the invention.

### DETAILED DESCRIPTION OF THE INVENTION

### I. Remote Design System

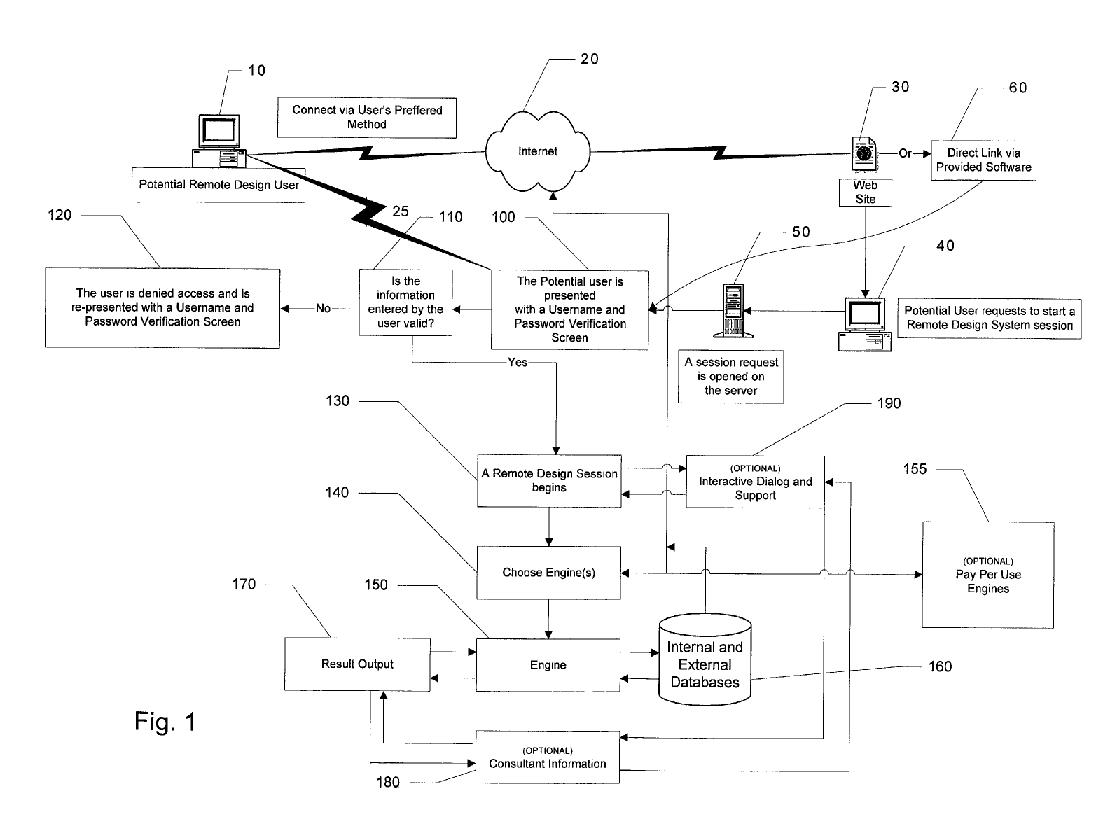

The remote design system (RDS) is accessed by a remote user via computer terminal 10, as shown in FIG. 1. An RDS can be open-ended, in that it provides tools for users in different disciplines. It is obvious to one of ordinary skill in the art of design system engines that the system can be made user specific, such that specific users, such as microwave circuit designers by way of example only, have available to them engines specifically tailored to their area of expertise.

Computer terminal 10 may remotely access the RDS using various methods known to those of ordinary skill in the art of remote computer systems. In a preferred embodiment, computer terminal 10 accesses web site 30 via the Internet 20 through a secure connection. Web site 30 may provide a link by which the user can initiate a request 40 on server 50 to access login screen 100. Web site 30 may, alternatively, provide a direct link 60 to access login screen 100, bypassing the need for a request 40 on server 50.

In an alternative preferred embodiment, computer terminal 10 utilizes other connection means, such as a modem and telephone line, wireless connection, or dedicated connection 25.

Once computer terminal 10 has connected to the system, the user is given an opportunity to log on. In a preferred embodiment, login screen 100 is used to enter a username and password and a validation procedure 110 is executed to confirm the information before the session is allowed to continue. If the username and password do not match, access is denied 120. After valid matching username and password are entered, an RDS session begins 130. There are other systems and methods for authenticating users that are known to those of ordinary skill in the art of remote computer systems.

Following validation, the user may be given a list of engines, described in greater detail below. In one embodiment, a single engine is provided, where the user's needs can be predetermined. In another embodiment, a computer selects the engine to be used by the user based on the user's entered profile. By way of example only, a user who specializes in the design of microwave circuits may be given access to the engines, data, and functionality particularly suited to the design of microwave circuits.

In an alternative preferred embodiment, the user is presented with a plurality of engines. Some engines 150 may be engines previously requested by the user. Some engines 150 may be additional pay-per-use engines 155 used in exchange for payment by the session. In an embodiment, the remote design system provider may choose the engine or engines for the user.

Some engines may be provided and maintained by the remote design system provider. Others might be virtual engines that are accessed by a direct link, via the Internet, or by other access means. Engines can by commercial, custom, or provided by third parties.

Once the engine or engines are chosen 140, the user can begin working on a model in the engine's environment, or workspace, where the model may be built, synthesized, analyzed, and optimized. In this workspace, data, which may be remotely located, local, and/or user-defined, may be read from or stored in various databases, libraries, and peripheral devices. Test and performance parameters may be set up to provide output of data results in various formats for the user's convenience and to optimize data analysis for the desired outcome.

In a preferred embodiment, possible engines for the user are structured on the basis of predetermined knowledge of markets, or on the relationship between system provider and the customer. The types of possible engines vary across many disciplines. By way of example only, engines may be specialized for systems that are electrical, mechanical, chemical, biological, medical, financial, etc., or even combinations thereof. By example, a possible preferred embodiment for microwave circuit designers would include engines capable of linear analysis of models based on mathematically represented circuit elements and cascaded elements. Such linear measurements may include S-parameter, H-parameter, Y-parameter, Z-parameter, admittance, impedance, group delay, noise, and VSWR, among others. Models for individual or cascaded elements can be retrieved from pre-existing libraries or constructed from data residing in databases 160, which may be local, remote, and/or defined by the user. These models are interconnected to create larger models, which may be systems or sub-systems, consisting of a plurality of elements.

Once a system or sub-system has been designed and modeled, test parameters may be utilized to measure the performance of the system or sub-system. Variable design parameters may be optimized by search methods, such as random, gradient, and quasi-Newton, by way of example only, or by error functions, such as least squares, minimax, and least path by way of example only.

The performance response of a system or sub-system is output 170 after a simulation is performed by the engine on the system. The output 170 may be in various formats, whose parameters and scale factors are preferably defined in the engine. Output 170 may be in the form of Cartesian graphs, Smith charts, polar plots, tabular data, digital data files, digital images, and video clips, although other forms of output are possible, as known to those of ordinary skill in the art of system simulations. In a preferred embodiment shown in FIG. 1, engine 150 may use output 170 for further simulation. For example, many simulations use reiterations to arrive at a particular solution or approximation of a solution. The final output 170 at the end of a session provides the ultimate outcome of the model test parameters. As with output 170 that is produced during a session the final output 170 can be in various formats. The user may wish to route the final output 170 to various destinations, such as back to another session, out to a consultant for evaluation, out to a system provider, or out to other subsequent parties.

Upon completion of a session, the user logs out of the session, and may, in a preferred embodiment, start a new session without logging in again, or, in an alternative preferred embodiment, be required to resubmit a valid username and matching valid password.

In a preferred embodiment, a user has the option of calling on the resources of a consultant 170 (or other third party) for aid with the design process. For example, a consultant may be become available at a pre-determined scheduled time and/or a consultant may be available on demand for real-time assistance. In a preferred embodiment, a consultant provides information 180, such as advice and assistance, through text-based chat sessions or through audio or video conferencing. In another preferred embodiment, a consultant may take control of a session and directly implement a design process. In either embodiment, the user would be in communication with the consultant to provide interactive dialog and support 190. In a preferred embodiment, consultant 180 not only has access to output 170, but can manipulate output 170 for use with further simulations on engine 150.

### II. The Engine

The engine may be defined as a software package that the user interfaces with to perform through simulations the synthesis of models, analysis of data and model performance, and optimization of model performance. In a preferred embodiment, the engine has a workspace (also called an environment), where a model is synthesized, analyzed, and/or optimized. In this workspace, data, which may be remotely located, local, and/or user-defined, may be read from or stored in various databases, libraries, and peripheral devices. Test and performance parameters may be set up to provide output of data results in various formats and to optimize data analysis for the desired outcome.

The possible engines for the user may be structured on the basis of predetermined knowledge of markets, and on the relationship between system provider and the customer. The types of possible engines vary across many disciplines. By way of example only, engines may be specialized for systems that are electrical, mechanical, chemical, biological, medical, financial, etc., or even combinations thereof.

In a preferred embodiment, engines are divided into categories based on cost to the user. Some engines may come standard with the remote design system and be accessible to all users, or at least to all users working in a certain discipline (e.g, microwave circuit design). Other engines may come as a premium service, and access may require larger payments by the users to the remote design system provider. Still others are pay-per-use, and the user's account is charged each time they are used. An additional possibility is to provide engines that are accessible as premium service or pay-per-use, and users may choose the arrangement under which they wish to access such engines.

### III. Output of the Engine

Output may be defined as the performance or outcome of model test parameters. The output may be in various formats, whose parameters and scale factors are preferably defined in the engine. The output may be in the form of Cartesian graphs, Smith charts, polar plots, tabular data, digital data files, digital images, and video clips, although other forms of output are possible. Many simulations use reiterations to arrive at a particular solution or approximation of a solution. The final output at the end of a session provides the ultimate outcome of the model test parameters. As with outputs produced during a session the final output can exist in various formats and can be stored, for example, on computer-readable media. The user may wish to visualize the output as graphical plots and/or tables of data, and may route the final output to various destinations.

### IV. Databases Accessed by the Remote Design System

Databases are used to store and access data. Examples of databases include model libraries of vendor parts, model libraries of generic parts, numerical data, user-defined data, and real-time data from peripheral devices. Examples of peripheral devices include sensors and network analyzers, and may be accessed remotely or locally, or by other means. Databases may be located remotely or locally, or even span remote and local locations. They may, for example contain final outputs formed by cascaded models generated by an engine and stored as S-parameter data files, to be used as library elements in subsequent sessions. Databases may include the input and the output for the sessions.

### V. Other Embodiments

It is obvious to those of ordinary skill in the art that many permutations and combinations of various examples illustrated above exist, and it would be obvious to those of ordinary skill in the art that these permutations and combinations may be implemented without undue experimentation, relying on the illustrations provided.

Additionally, while there have been shown and described and pointed out fundamental novel features of the invention as applied to embodiments thereof, it will be understood that various omissions and substitutions and changes in the form and details of the invention, as herein disclosed, may be made by those skilled in the art without departing from the spirit of the invention. It is expressly intended that all combinations of those elements and/or method steps which perform substantially the same function in substantially the same way to achieve the same results are within the scope of the invention. It is the intention, therefore, to be limited only as indicated by the scope of the claims appended hereto.

1. A method for conducting remote design comprising the steps of:
validating login information related to a remote user having access to a computer terminal;
providing a plurality of engines;
selecting at least one of said plurality of engines;
providing an engine workspace related to said at least one of said plurality of engines for building at least one model; and
running a simulation of said at least one model utilizing said at least one of said plurality of engines to create output data.

2. The method for conducting remote design of claim 1, wherein said plurality of engines includes at least one pay-per-use engine.

3. The method for conducting remote design of claim 1, wherein said plurality of engines includes at least one virtual engine.

4. The method for conducting remote design of claim 1, wherein said selecting at least one of said plurality of engines is conducted from said computer terminal.

5. The method for conducting remote design of claim 1, further comprising the step of providing access to a consultant for assistance with said building at least one model.

6. A system for conducting remote design comprising:
a login screen for validating information related to a remote user having access to a computer terminal;
a plurality of engines, wherein at least one of said plurality of engines is selected after said information is validated;
at least one engine workspace related to said at least one of said plurality of engines for building at least one model; and
at least one server for running a simulation of said at least one model utilizing said at least one of said plurality of engines to create output data.

7. The system for conducting remote design of claim 6, wherein said plurality of engines includes at least one pay-per-use engine.

8. The system for conducting remote design of claim 6, wherein said plurality of engines includes at least one virtual engine.

9. The system for conducting remote design of claim 6, wherein said selecting at least one of said plurality of engines is conducted from said computer terminal.

10. The system for conducting remote design of claim 6, further comprising a communication route to a consultant for assistance with said building at least one model.

11. A system for conducting remote design comprising:
means for validating information from a user having access to a computer terminal;
means for selecting at least one engine from a plurality of engines;
means for providing a workspace related to said at least one engine in which at least one model is built; and
means for running a simulation of said at least one model utilizing said at least one engine to create output data.

12. The system for conducting remote design of claim 11, wherein said plurality of engines includes at least one pay-per-use engine.

13. The system for conducting remote design of claim 11, wherein said plurality of engines includes at least one virtual engine.

14. The system for conducting remote design of claim 11, wherein said means for selecting at least one engine is performed at said computer terminal.

15. The system for conducting remote design of claim 11, further comprising means for communicating with a consultant providing assistance with said building at least one model.

16. A computer-readable medium having stored thereon a plurality of instructions, said plurality of instructions including instructions which, when executed by a processor, cause said processor to perform the steps of:
validating login information related to a remote user having access to a computer terminal;
providing access to a plurality of engines;
providing for the selection of at least one of said plurality of engines;
providing an engine workspace related to said at least one of said plurality of engines for building at least one model; and
running a simulation of said at least one model utilizing said at least one of said plurality of engines to create output data.

17. The computer-readable medium of claim 16, wherein said plurality of engines includes at least one pay-per-use engine.

18. The computer-readable medium of claim 16, wherein said plurality of engines includes at least one virtual engine.

19. The computer-readable medium of claim 16, wherein said selection of at least one of said plurality of engines is conducted from said computer terminal.

20. The computer-readable medium of claim 16, further comprising the step of providing access to a consultant for assistance with said building at least one model.

21. A method for conducting remote design comprising the steps of:
providing at least one engine;
providing an engine workspace related to said at least one engine for building at least one model; and
running a simulation of said at least one model utilizing said at least one of said plurality of engines to create output data.

22. The method for conducting remote design of claim 21, further comprising the step of selecting said at least one engine from a plurality of engines.

23. The method for conducting remote design of claim 21, further comprising the step of validating login information related to a remote user having access to a computer terminal.

24. A system for conducting remote design comprising:
at least one engine;
at least one engine workspace related to said at least one engine for building at least one model; and
at least one server for running a simulation of said at least one model utilizing said at least one engine to create output data.

25. The system for conducting remote design of claim 24, wherein said at least one engine is selected from a plurality of engines.

26. The system for conducting remote design of claim 24, further comprising a login screen for validating information related to a remote user having access to a computer terminal.
